(19) United States
(12) Patent Application Publication
(10) Pub. No.: US 2018/0246578 A1
(43) Pub. Date: Aug. 30, 2018

(54) METHOD OF DEVICE FOR IDENTIFYING AND ANALYZING SPECTATOR SENTIMENT

(71) Applicant: AGT INTERNATIONAL GMBH, Zurich (CH)

(72) Inventors: Gdalia LENZ, Zikhron Ya'aqov (IL); Thomas BADER, Pfungstadt (DE)

(21) Appl. No.: 15/758,433

(22) PCT Filed: Sep. 6, 2016
(86) PCT No.: PCT/IL2016/050980

§ 371 Date: Mar. 8, 2018

Related U.S. Application Data
(60) Provisional application No. 62/216,490, filed on Sep. 10, 2015.

(51) Int. Cl. G06F 3/01; H05B 37/02; H04W 4/38

(52) U.S. Cl. CPC G06F 3/017; H04W 4/38; H05B 37/0227

(57) ABSTRACT

A system and computer-implemented method for determining and using sentiment-related data of a person in an audience of an event, the method comprising: a wearable device comprising: a sensor; a processor for identifying a gesture of a user wearing the wearable device based on input received from the sensor; and a transmitter for transmitting gesture-related data associated with the gesture to a computing device.

### TECHNICAL FIELD

The presently disclosed subject matter relates to analyzing spectator sentiment, and more particularly, to determining and analyzing a spectator's sentiment from gestures.

### BACKGROUND

Bidirectional interaction between spectators of sport or entertain cut events and the game or show environment is not supported by existing systems. Information related to the game, event or show may be provided to both remote and on-site spectators by vocal or visual means. However, there is no technological way to assess the spectators' reaction to whatever happens in the game or the show.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A illustrates the main components in a first embodiment of a system for determining and analyzing spectators' sentiment, in accordance with certain embodiments of the presently disclosed subject matter;

FIG. 1B illustrates the main components in a second embodiment of a system for determining and analyzing spectators' sentiment, in accordance with certain embodiments of the presently disclosed subject matter;

FIG. 2 illustrates a block diagram of the modules in a system for determining and analyzing spectators' sentiment, in accordance with certain embodiments of the presently disclosed subject matter; and

FIG. 3 illustrates a flowchart of steps in a method for determining and analyzing spectators' sentiment, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “representing”, “comparing”, “generating”, “assessing”, “matching”, “updating” or the like, refer to the action(s) and/or process(es) of a computer that manipulate and/or transform data into other data, said data represented as physical, such as electronic, quantities and/or said data representing the physical objects. The term “computer” should he expansively construed to cover any kind of electronic device with data processing capabilities.

The operations in accordance with the teachings herein may be performed by a computer specially constructed for the desired purposes or by a general-purpose computer specially configured for the desired purpose by a computer program stored in a computer readable storage medium.

Embodiments of the presently disclosed subject matter are not described with reference to any particular programming language. It will be appreciated that a variety of programming languages may be used to implement the teachings of the presently disclosed subject matter as described herein.

Bidirectional interaction between spectators of sport or entertainment events, including on-site and remote spectators, and the game or show environment is not supported by existing systems. Information related to the game, event or show (collectively referred to as “game”) may be provided to both remote and on-site spectators by vocal or visual means. However, there is no technological way to assess the spectators' reaction to whatever happens in the game. A spectator can shout, make gestures, or the like, for both positive arid negative events, but currently there is no wav of telling what sentiment a particular person is experiencing, and even more so for a multiplicity of spectators, whether at the game site or watching at a remote location.

Some spectators share their feelings about the game on social networks such as Facebook or Twitter. However, only a small minority of the spectators does that. This is partly due to the fact that such sharing requires explicit actions, for example taking a smartphone out of the bag or pocket, holding it and typing, which may distract them from the game. Additionally, it is not always straight forward to automatically understand what the user means from the text, and certainly to quantify this for a large number of spectators.

It will be appreciated that gaining such insights may be used in a variety of ways, for example offering experience-enriching services, making relevant suggestions or promotions for products, services or content, or the like.

Some embodiments of the disclosed subject matter provide for measurement of the level of engagement or emotions of spectators in an event, whether the spectator is on-site or remote, possibly while taking the context of the game into account using a device attached to the spectator. Thus, some embodiments of the disclosed subject matter may enable spectators to interact with the environment and the game, in a non-intrusive and non-distracting way. Such interaction may provide for a number of goals, such as but not limited to: creating new content related to the game, which can be shared and used to augment other information; creating real-time insights to improve targeted and personalized information sharing; enhance the interactive experience of spectators; connect remote and on-site spectators; connect the experience during the game pre- and post-experiences, or the like.

Some embodiments of the disclosed subject matter use motion and possible sound made by spectators. Many spectators make hand or arm gestures or sounds during the game, and by measuring and characterizing such motions, the sentiment and engagement level of the spectator may be realized.

Sonic embodiments of the disclosed subject matter relate to a wearable item, which is preferably wearable on one's hand or arm, such as a bracelet, a wrist band or a ring, collectively referred to as a “bracelet”, which is outfitted with one or more motion sensors, e.g., a 3-axis accelerometer. The bracelet has a processor adapted for receiving measurements from the motion sensors, and for determining whether the measurements indicate that the user has performed a predetermined gesture, such as raising his arm, sending his arm forward, waving his arm, or the like. An indication of the identified gesture may then be transmitted using a short range communication protocol to a computing device, such as a smartphone carried by the user, which may transmit the data further to a server that may receive such data from a multiplicity of spectators, analyze it and optionally take an action upon it.

In some embodiments, the gesture as stored on the bracelet may be associated with an emotion. For example, raising one's hand may indicate a positive emotion, while sending one's arm forward may indicate a negative emotion. Thus, the bracelet may identify the sentiment or emotion associated with the performed gesture and may report it to the computing platform. In other embodiments, the emotion associated with the performed gesture may be identified by the computing platform such as the smartphone, or by the server, such that the bracelet merely determines whether and which known gesture has been performed. In any case, the gesture is matched to a positive or negative emotion or sentiment, such that insights related to the emotion or sentiment of multiple event spectators can be obtained.

The bracelet may be initially configured to identify one gesture, for example a gesture indicating a positive emotion; two gestures wherein one indicates a positive emotion and the other negative, or any number of predetermined gestures.

In some embodiments, the bracelet may be equipped with one or more visual indicators such LEDs. Identifying a gesture may cause providing visual or vocal indication, such as turning on a LED. For example, a bracelet configured to identify two gestures may have two LEDs, wherein identification of each of the gestures causes one of the LEDs to turn on. The identification of a gesture associated (by the bracelet or by a computing platform) with a positive emotion may cause a green LED to turn on, while identification of a gesture associated with a negative emotion may cause a red LED to turn on.

While the bracelet may identify gestures implicitly, the bracelet may also be equipped with controls for a user to explicitly indicate emotions. For example, a bracelet may be equipped with two buttons which the user can switch, or touch areas the user can touch, one for expressing a positive emotion and the other for expressing a negative emotion. The indications provided explicitly may also be transmitted to the computing platform and therefrom to the server. The indications may also cause the turning on of LEDs or other indicators as described above.

In some embodiments, the user may program the bracelet, for example using an application executed by the smartphone and communicating with the bracelet, to introduce new gestures to the bracelet, such that the bracelet may recognize them. The gestures may be introduced by performing the gestures at least a predetermined number of times, such that the bracelet may study the relevant motion patterns. Additionally or alternatively, the user may select one or more gestures from a list displayed by the smartphone, and the motion patterns of the gestures may be uploaded to the bracelet which may then recognized them.

A gesture may be identified by the bracelet by extracting features or patterns from the data provided by the motion sensors, such as amount, speed, acceleration or direction of motion. The bracelet processor may use a classifier or another engine for identifying a specific gesture based on the extracted features, patterns or combinations. In some embodiments, clustering by the bracelet may also refer to analyzing collected movements to identify new gestures and not only predetermined ones.

In further embodiments, movements or some characterization thereof may be received from multiple spectators, and analyzed, for example by clustering, by the server to reveal new common gestures used by the spectators, for example in a new sports branch. This analysis or clustering may save setup and training time of the system to new gestures. The analysis or clustering may proceed simultaneously with analysis of current gestures as reported form devices.

In some embodiments, realizing sentiments may combine analyzing motions with analyzing data from additional information sources, such as but not limited to analyzing the user's voice to retrieve positive or negative sentiment.

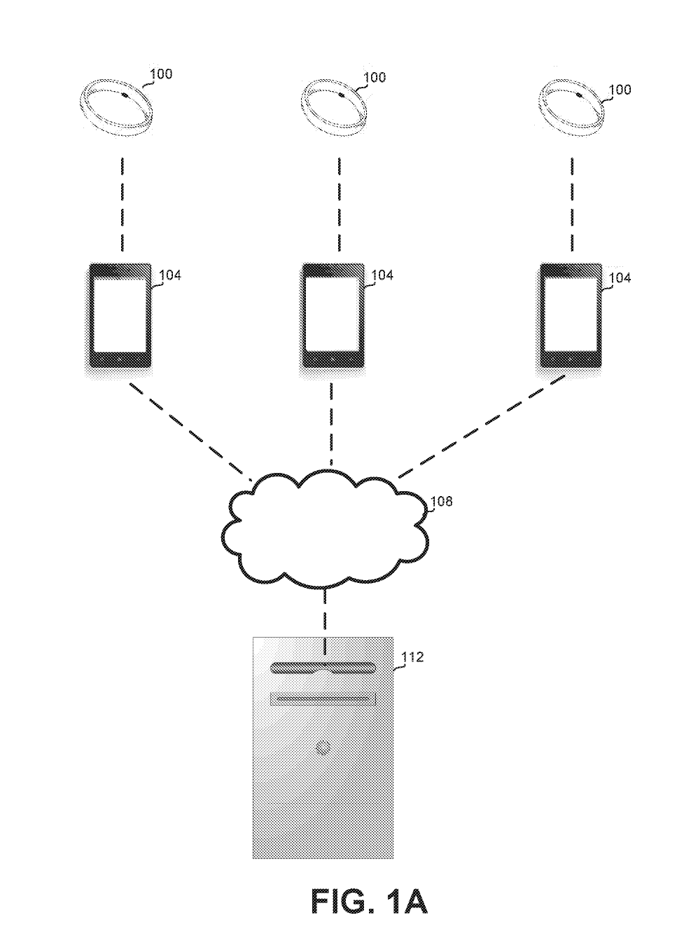

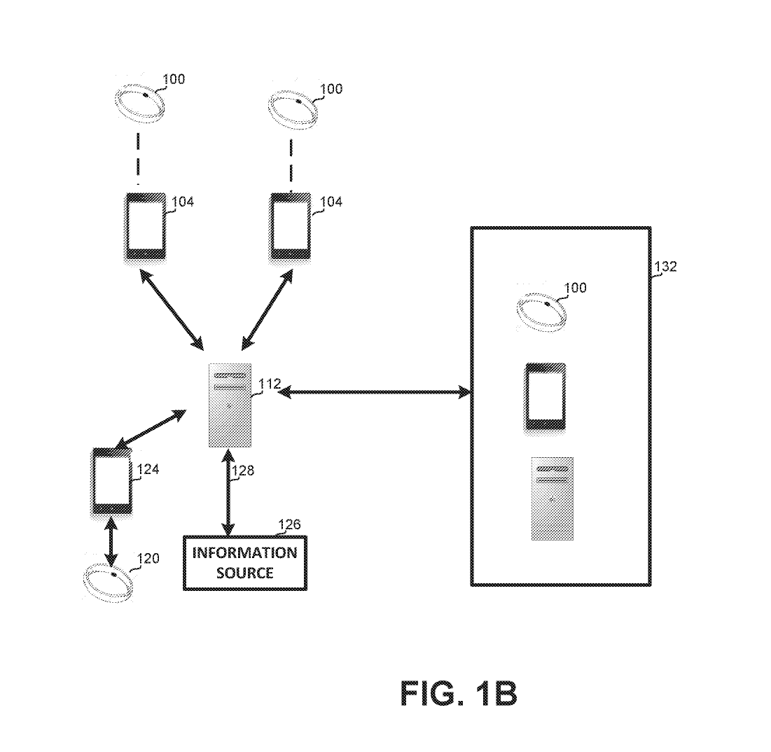

Referring now to FIG. 1A, illustrating the components in an embodiment of a system for identifying and analyzing spectator sentiment, in accordance with the some embodiments of the disclosed subject matter.

A spectator in a game, whether on-site or at a remote location, such as the home, a bar, or the like, may wear a wearable device 100, such as a bracelet, wrist band, arm band, ring, or the like. However, in some embodiments spectators or participants in other location, for example form home, may also wear and use wearable device 100.

Wearable device 100 may be equipped with one or more motion sensors, for sensing movements of wearable device 100, which may be caused by the spectator making moves or gestures. Wearable device 100 may be equipped with a processor and optionally with a storage device. The storage device may store motion features, characteristics or patterns of predetermined gestures. The processor may be configured to identify whether data provided by the sensor is, at least with predetermined probability, caused by the user performing any of the predetermined gestures.

The identified gesture may or may not be associated with an emotion, a sentiment, or the like.

Wearable device 100 may also be equipped with controls such as buttons, touch areas, or the like, for a user to explicitly enter data, related to for example to emotion or sentiment.

Wearable device 100 may transmit an indication, such as an ID and indication for implicitly identified or explicitly provided gesture or emotion, to a nearby computing platform, such as smartphone 104. Smartphone 104 may be configured, for example by executing an application, to transmit data related to the gesture identifier as received, or an associated emotion or sentiment to server 112, which may be configured to receive such input from a multiplicity of devices via channel 108, such as the internet, cellular communication, or the like, and to analyze them. For example, such analysis may comprise determining the percentage and locations of happy/unhappy spectators, the emotional trends of spectators, or the like.

Server 112 may then determine an action to be taken, for example announcing that the first spectators to press the button associated with the positive emotion, or performing the gesture associated with the positive emotion will win a prize; announcing that a singer will perform a certain song if enough spectators perform a predetermined gesture, or the like.

In some embodiments, the implicit or explicit information provided by spectators trough wearable device 100 may be used to influence presentation of impressions or ads, for example changing the timing or content, or to adapt the physical environment on site, for example turn on the lights.

In sonic embodiments, the level of engagement or emotional state can be matched with context information by correlating the state in time, to determine the reason for the state engagement level, or the like. For example positive or negative emotion may be correlated with an important point gained in sports game.

In some embodiments, the implicit or explicit information gathered by the wearable device can be linked to content, e.g., to video or images showing the situation and environment in which the information was generated, which can then be displayed, distributed, or the like.

It will be appreciated that the implicit or explicit information may also be gathered from remote spectators equipped with a wearable device, who can also be taken into account to enrich the on-site experience, e.g., by showing engagement level of remote spectators together with content created by them such as text messages, images or videos, thus providing for creating a connected community around a game.

In some embodiments, the physical or touch buttons can be used to rate attractions, scenes, events, or the like, which may be used for creating new content or improving processes of organizers and attractions.

Referring now to FIG. 1B, illustrating the components in another embodiment of a system for identifying and analyzing spectator sentiment, in accordance with the some embodiments of the disclosed subject matter. The system may comprises wearable devices 100, smartphones 104, channel 108 (not shown for simplicity) and server 112 as in FIG. 1A. The communication between these entities may similarly include for example identified gestures, engagement level, emotions, sentiments, or the like.

Some wearable devices and computing platforms, such as wearable device 120 and computing platform 124 may be worn and used by people not present at the event, for example watching from home, from a bar, or the like. Information from these spectators may be received in the same manner as from wearable device 100 and computing platform 104.

Additionally, information may be sent from computing platform 104 or computing platform 124 to wearable devices 100 or 120, which information may include triggers or other commands providing feedback to the wearable devices, commands to turn on an indicator within the wearable device or to send particular information, or the like.

Additionally, server 112 may receive from information source 126 information such as context 128, relating for example to the game or event, their status, impressions, video, audio, or the like. Information source 126 may be any human or data providing platform. Server 112 may incorporate context 128 into the analysis of data received from computing platforms 104 and 124, or may transmit some of it to other computing platforms.

Additionally or alternatively, server 112 may send information or commands to any other entity 132, such as additional wearable devices, computing platforms such as smartphones, computing platforms such as servers associated with content creators, distributors, clients, providers, marketing entities, or the like. The information may include insights related to the spectator emotion analysis, engagement type and level, statistics or other content, triggers, audio or video segments, or the like. Additionally or alternatively, the information or commands may also be sent to any computing device 104 or 124.

It will also be appreciated that some embodiments may combine some components, data, communications or the like from FIG. 1A and/or FIG. 1B.

It will be appreciated that the gestures may include two- or more-user gestures, which may be initiated, for example, by “bumping”. A wearable device may be adapted to recognize a second device in its vicinity, and to sense that the second device has bumped into it. Then, a gesture performed in combination by the wearable devices may be identified by one of the devices, two of them, or a computing device external to the wearable devices and receiving input from the two devices. The gesture may be a combined gesture, comprising a first movement made by a first person wearing a first wearable device and a second movement made by a second person wearing a second wearable device.

Such gesture may then be reported as any other gesture, and may be associated with a positive or negative emotion.

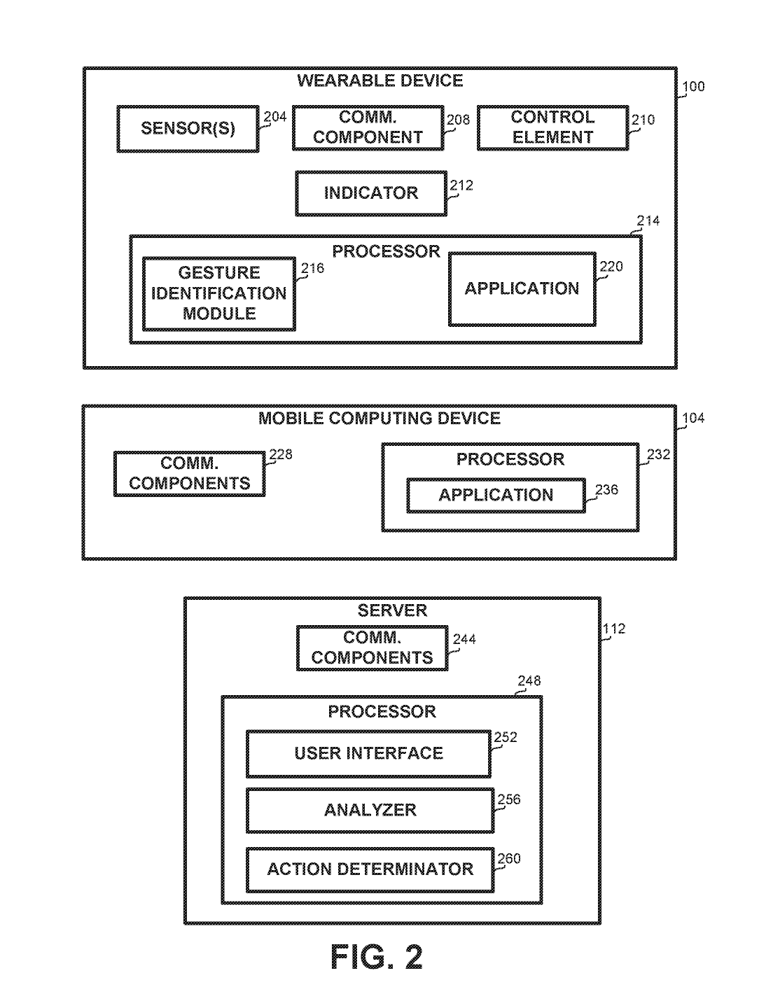

Referring now to FIG. 2, showing a block diagram of the modules in an exemplary system for determining and analyzing sentiment, in accordance with certain embodiments of the presently disclosed subject matter,

The system may comprise one or more wearable devices 100, which may be worn by one or more spectators in a game, show, or the like.

Wearable device 100 may comprise one or more sensors 204, such as motion sensors, for example accelerometers.

Wearable device 100 may comprise communication component 208 for communicating with devices such as a smartphone. Communication component 208 may provide for short range communication, such as using the Bluetooth protocol. Alternatively, communication component 208 may provide for full range communication, such as Wi-Fi or cellular communication.

Wearable device 100 may comprise control element 210 such as one or more physical buttons or touch areas, which the user can press, touch, or otherwise activate to explicitly express sentiment. For example wearable device 100 may comprise two such buttons, one for expressing positive sentiment and the other for expressing negative sentiment.

Wearable device 100 may comprise an indicator 212, for example one or more LEDs which can be turned on in accordance with identified gestures or explicitly entered indications, for example using control element 210. Alternatively, indicator 212 may provide vocal indication, or any other noticeable indication.

Wearable device 100 may comprise processor 214, such as a Central Processing Unit (CPU), a microprocessor, an electronic circuit, an Integrated Circuit (IC) or the like. Processor 214 may be configured to provide the required functionality, for example by loading to memory and activating gesture identification module 216 or application 220.

Gesture identification module 216 may receive input from sensors 204, and may analyze them, for example by extracting motion characteristics, and comparing them to motion characteristics associated with one or more gestures stored on a storage device associated with wearable device 100.

In some embodiments, gesture identification module 216 may identify an intensity level of a gesture. For example, a user may raise his hand a little or a lot, which will indicate the same sentiment but with different intensities.

Application 220 may provide for activating gesture identification module 216, communication component 208 receiving explicit input from control element 210, activating indicator 212, or other components.

Each wearable device 100 may be in communication with a mobile computing platform 104, for example a smartphone carried by a user wearing wearable device 100.

Mobile computing platform 104 may comprise one or more communication components 228, for communicating with wearable device 100, for example using a short range protocol, and for communicating with server 112 for transmitting gestures or sentiments expressed by the user implicitly or explicitly, and optionally for receiving data, suggestions, or the like.

Computing platforms 104 may comprise processor 232 which may also be implemented as a CPU, a microprocessor, an electronic circuit, an IC, or the like.

Processor 232 may be configured to operate in accordance with the code instructions of application 236. Application 236 may be adapted for handling implicit or explicit indications received from wearable device 100 regarding gestures or sentiments, and to transmit them to server 112. Application 236 may also be operative in defining additional or alternative gestures to be identified by wearable device 100, for example by guiding a user in performing gestures, such that their characteristics may be stored for comparison, wherein the gestures may or may not be associated with a sentiment, or by guiding a user in uploading characteristics of one or more gestures from a predetermined list to wearable device 100 and configuring wearable device 100 to recognize them.

It will be appreciated that processor 214 of wearable device 100 or processor 232 of mobile computing device 236 may, in sonic embodiments, be operative in associating an identified gesture with a sentiment or emotion, which may be positive or negative. If the association is not made by processor 214 of wearable device 100 than wearable device 100 may transmit an indication to the identified gesture to mobile computing device 236.

Server 112 may be adapted to receive input from a multiplicity of mobile computing devices 104, to analyze the input, or to initiate an action based on the analysis results.

Server 112 may comprise processor 248, which may also be implemented as a CPU, a microprocessor, an electronic circuit, an IC, or the like.

In some embodiments, the association may be made by processor 248 of server 112, in which case mobile computing device 236 transmits an indication of the gesture rather than of the sentiment or emotion.

Server 112 may comprise one or more communication components 244 for communicating with mobile computing devices 104, with other platforms such as providers' servers, databases, platforms of entities associated with the games, advertisers, or the like.

Processor 248 may be configured to display and operate user interface for an operator, which may be used for viewing the analysis results, entering offers, or the like.

Processor 248 may also be adapted for executing analyzer 256, for analyzing the received implicit or explicit input from a multiplicity of users. Analyzer 256 may be operative in analyzing the number of spectators that expressed positive or negative emotion or sentiment, their geographic distribution whether over a stadium or at remote locations, the average intensity for each sentiment, or the like.

Processor 248 may also be adapted for executing action determinator 260, for determining an action to be taken upon the analyzed data. For example, if sentiment level is determined to be low, it may be advertised that the first ten spectators to make a particular gesture may win a prize, that all spectators that make a particular gesture may win a voucher, that if enough people make a gesture another song will be sung, or the like.

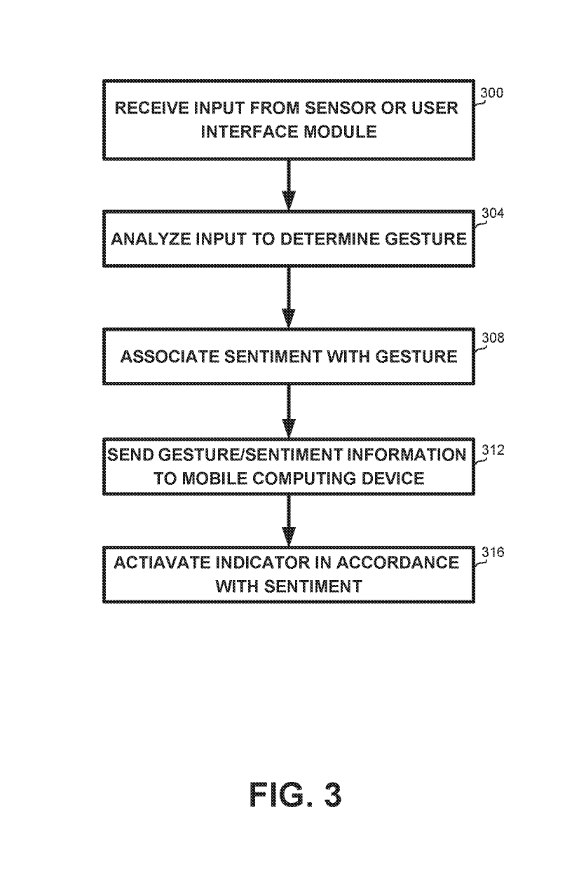

Referring now to FIG. 3, illustrating a flowchart of steps in a method for determining and analyzing spectators' sentiment, in accordance with certain embodiments of the presently disclosed subject matter.

On step 300, input may be received from a sensor or a control located on a wearable device. The sensor may be a motion sensor such as an accelerometer.

On step 304, the input may be analyzed to determine a gesture. Analysis may include extracting features from the input, and comparing the features to stored features associated with known gestures. In some embodiments, the intensity of the gesture may also be estimated.

On step 308, an emotion or sentiment may be associated with the identified gesture.

On step 312, indication of the gesture may be transmitted to a computing device, such as smartphone carried by the user. If the gesture has been associated with an emotion or sentiment by the wearable device, then an indication of the emotion or sentiment may be transmitted to the computing device.

On step 316, one or more indicators located on the wearable device may be activated. For example, a LED may be turned on or may blink if a particular gesture or sentiment is identified.

It will be appreciated that not all disclosed steps or their order are mandatory. Thus, it will further be appreciated that some steps may be omitted, performed at different order, or the like.

The disclosed subject matter relates to a simple device wearable by a user which may be used to implicitly or explicitly express sentiment. The device being wearable frees the user's hands and does not require him or her to fetch a device such as a smartphone, hold it and activate it to enter data. Even further, implicitly indicating emotions or sentiment enables a user to behave as they normally do, and avoid extra actions that may distract them. The implicit expression may enable getting insight related to spectators who would normally not take an active step.

The gathered information may enable the understanding of the spirit of the spectators, or the distribution thereof, and may enable providing incentives for certain actions.

The device may be made attractive, and may be made simple enough to be distributed as a giveaway, for example to fans of a sports club, frequent concert visitors, or the like.

It is noted that the teachings of the presently disclosed subject matter are not bound by the method and system described with reference to FIGS. 1-3. Equivalent and/or modified functionality can be consolidated or divided in another manner and can be implemented in any appropriate combination of software, firmware and hardware and executed on a suitable device.

Each component of the system may be a standalone network entity, or integrated, fully or partly, with other network entities. Those skilled in the art will also readily appreciate that data repositories may be embedded or accessed by any of the components and can be consolidated or divided in any manner. Databases can be shared with other systems or be provided by other systems, including third party equipment.

It is also noted that whilst the system of FIG. 2 corresponds to the flowchart of FIG. 3, this is by no means binding, and the steps can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A system for determining and using sentiment-related data of a person in an audience of an event, comprising:
a wearable device comprising:
a sensor;
a processor for identifying a gesture of a user wearing the wearable device based on input received from the sensor; and
a transmitter for transmitting gesture-related data associated with the gesture to a computing device.

2. The system of claim 1, wherein the wearable device is selected from the group consisting of: a bracelet, a wrist band, and a ring.

3. The system of claim 1, wherein the sensor comprises at least one motion sensor and the gesture is identified from motions sensed by the user.

4. The system of claim 3, wherein the at least one motion sensor is at least one three dimensional accelerometer.

5. The system of claim 1, wherein the wearable device further comprises an indicator that provides an indication in accordance with the gesture.

6. The system of claim 5, wherein the indication comprises turning on a light in response to identifying the gesture.

7. The system of claim 1, wherein the wearable device further comprises a user interface element for receiving explicit input from the user.

8. The system of claim 1, wherein information based on the explicit input is transmitted by the transmitter.

9. The system of claim 1, further comprising:
a server, comprising:
a transceiver for receiving the gesture-related data from at least one wearable device; and
a second processor for:
analysing the gesture-related data and obtain analysis results; and
determining an action to be taken upon the analysis results.

10. The system of claim 9, wherein analysing the gesture-related data comprises determining a number of wearable devices from which the indication of the gesture was transmitted.

11. The system of claim 9, wherein analysing the gesture-related data comprises determining locations of wearable devices from which the gesture-related data was transmitted.

12. The system of claim 9, wherein the action to be taken comprises publishing an incentive to performing an act.

13. The system of claim 9, wherein the gesture-related data is transmitted from the wearable device to a mobile computing device associated with the user, and the server receives the gesture-related data from a multiplicity of mobile computing devices.

14. The system of claim 13, wherein communication between the wearable device and the mobile computing device is by a low power communication link, and communication between mobile computing device and the server is by cellular communication or Wi-Fi communication.

15. The system of claim 13, wherein the mobile computing device is a smartphone.

16. The system of claim 13, wherein the mobile computing device executes an application.

17. The system of claim 16, wherein the application is configured for training the wearable device to recognize at least one other gesture.

18. The system of claim 9, wherein the server further receives information related to the event.

19. The system of claim 9, wherein the server is further adapted to transmit information or commands related to the event to a wearable device or computing platform.

20. The system of claim 1, wherein the processor is further adapted to:
identify that a second wearable device in its vicinity has made contact with the wearable device.

21. The system of claim 20, wherein the processor or another processor is adapted to identify a gesture comprising a first movement made by a first person wearing a first wearable device and a second movement made by a second person wearing a second wearable device.

22. A computer-implemented method for providing an indication to a gesture of a user, comprising:
receiving input from a sensor embedded within a wearable device;
identifying a gesture of a user wearing the wearable device based on the input; and
transmitting gesture-related data to a computing device.

23. The method of claim 22, further comprising receiving explicit input from the user through a user interface.

24. The method of claim 22, further comprising activating an indicator which provides an indication in accordance with the gesture.

25. The method of claim 22, further comprising identifying a gesture comprising a movement made by a first person wearing a first wearable device and a second movement made by a second person wearing a second wearable device
